(19) United States
(12) Patent Application Publication
(10) Pub. No.: US 2018/0173300 A1
(43) Pub. Date: Jun. 21, 2018

(54) INTERACTIVE VIRTUAL OBJECTS IN MIXED REALITY ENVIRONMENTS

(71) Applicant: Microsoft Technology Licensing, LLC, Redmond, WA (US)

(72) Inventors: Julia Schwarz, Redmond, WA (US); Hrvoje Benko, Seattle, WA (US); Andrew D. Wilson, Seattle, WA (US); Robert Charles Johnstone Pengelly, Seattle, WA (US); Bo Robert Xiao, Pittsburgh, PA (US)

(21) Appl. No.: 15/384,235

(22) Filed: Dec. 19, 2016

(51) Int. Cl. G06F 3/01; G02B 27/01; H04N 13/02; G06T 19/00; G06T 7/73; G06F 3/0481; G06T 19/20

(52) U.S. Cl. CPC G06F 3/011; G02B 27/017; H04N 13/0203; G06T 2219/2021; G06T 7/74; G06F 3/04815; G06T 19/20; G06T 19/006

(57) ABSTRACT

Disclosed are an apparatus and a method of detecting a user interaction with a virtual object. In some embodiments, a depth sensing device of an NED device receives a plurality of depth values. The depth values correspond to depths of points in a real-world environment relative to the depth sensing device. The NED device overlays an image of a 3D virtual object on a view of the real-world environment, and identifies an interaction limit in proximity to the 3D virtual object. Based on depth values of points that are within the interaction limit, the NED device detects a body part or a user device of a user interacting with the 3D virtual object.

### BACKGROUND

Near-to-eye display (NED) devices such as head-mounted display (HMD) devices have been introduced into the consumer marketplace recently to support visualization technologies such as augmented reality (AR) and virtual reality (VR). An NED device may include components such as light sources, microdisplay modules, controlling electronics, optics, etc.

NED devices can use depth sensing technology to determine a person's location in relation to nearby objects or to generate an image of a person's immediate environment in three dimensions. Depth sensing technology can employ stereoscopic vision, time-of-flight (ToF) depth camera or structured light depth camera. Such a device can create a map of physical surfaces in the user's environment (called a depth image or depth map) and, if desired, render a three-dimensional (3D) image of the user's environment.

### SUMMARY

Introduced here are at least one apparatus and at least one method (collectively and individually, “the technique introduced here”) for detecting a user interaction with a virtual object. In some embodiments, a depth sensing device of an NED device receives a plurality of depth values. The depth values correspond to depths of points in a real-world environment relative to the depth sensing device. The NED device overlays an image of a 3D virtual object on a view of the real-world environment, and identifies an interaction limit in proximity to the 3D virtual object. Based on depth values of points that are within the interaction limit, the NED device detects a body part or a user device of a user interacting with the 3D virtual object.

In certain embodiments, the NED device confines a search range for the body part or the user device to the interaction limit of the 3D virtual object, and identifies a set of depth values that correspond to points within the search range and are associated with a shape of the body part or the user device. The NED device can further refine the search range for the body part or the user device based on a contour recognized from an image of the real-world environment.

In certain embodiments, the 3D virtual object includes a virtual surface in proximity to or overlapping with a surface of a real-world object in the real-world environment, and the interaction limit of the 3D virtual object for interaction detection includes a space in front of the virtual surface.

Other aspects of the disclosed embodiments will be apparent from the accompanying figures and detailed description.

This Summary is provided to introduce a selection of concepts in a simplified form that are further explained below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 shows an example of an environment in which a virtual reality (VR) or augmented reality (AR) enabled head-mounted display device (hereinafter “HMD device”) can be used.

FIG. 2 illustrates a perspective view of an example of an HMD device.

FIG. 3 illustrates an example of a process of detecting a user interaction with a virtual object in the AR space.

FIG. 4 illustrates an example of a depth map of a real-world environment.

FIG. 5 illustrates an example of a virtual surface overlapping with a surface of a real-world object.

FIG. 6 illustrates an example of a reflectivity image of a real-world environment.

FIG. 7 illustrates a region of depth values that correspond to points inside of bounds of a virtual surface.

FIG. 8 illustrates an example of a search range which represents a shape of a body part of a user.

FIG. 9 shows a high-level example of a hardware architecture of a system that can be used to implement any one or more of the functional components described herein.

### DETAILED DESCRIPTION

In this description, references to “an embodiment,” “one embodiment” or the like mean that the particular feature, function, structure or characteristic being described is included in at least one embodiment introduced here. Occurrences of such phrases in this specification do not necessarily all refer to the same embodiment. On the other hand, the embodiments referred to also are not necessarily mutually exclusive.

The following description generally assumes that a “user” of a display device is a human. Note, however, that a display device according to the disclosed embodiments can potentially be used by a user that is not human, such as a machine or an animal. Hence, the term “user” can refer to any of those possibilities, except as may be otherwise stated or evident from the context. Further, the term “optical receptor” is used here as a general term to refer to a human eye, an animal eye, or a machine-implemented optical sensor designed to detect an image in a manner analogous to a human eye. Similarly, the term “eye” refers generally to the eye of a human or animal, or an optical sensor of a machine.

Virtual reality (VR) or augmented reality (AR) enabled head-mounted display (HMD) devices and other near-to-eye display systems may include transparent display elements that enable users to see concurrently both the real world around them and AR content displayed by the HMD devices. An HMD device may include components such as light-emission elements (e.g., light emitting diodes (LEDs)), waveguides, various types of sensors, and processing electronics. HMD devices may further include one or more imager devices to generate images (e.g., stereo pair images for 3D vision) in accordance with the environment of a user wearing the HMD device, based on measurements and calculations determined from the components included in the HMD device.

An HMD device may also include a depth imaging system (also referred to as depth sensing system or depth imaging device) that resolves distances between the HMD device worn by a user and physical surfaces of objects in the user's immediate vicinity (e.g., walls, furniture, people and other objects). The depth imaging system may include a structured light or ToF camera that is used to produce a 3D image of the scene. The captured image has pixel values corresponding to the distance between the HMD device and points of the scene.

The HMD device may include an imaging device that generates holographic content based on the scanned 3D scene, and that can resolve distances, for example, so that holographic objects appear at specific locations relative to physical objects in the user's environment. 3D imaging systems can also be used for object segmentation, gesture recognition, and spatial mapping. The HMD device may also have one or more display devices to overlay the generated images on the field of view of an optical receptor of a user when the HMD device is worn by the user. Specifically, one or more transparent waveguides of the HMD device can be arranged so that they are positioned to be located directly in front of each eye of the user when the HMD device is worn by the user, to emit light representing the generated images into the eyes of the user. With such a configuration, images generated by the HMD device can be overlaid on the user's three-dimensional view of the real world.

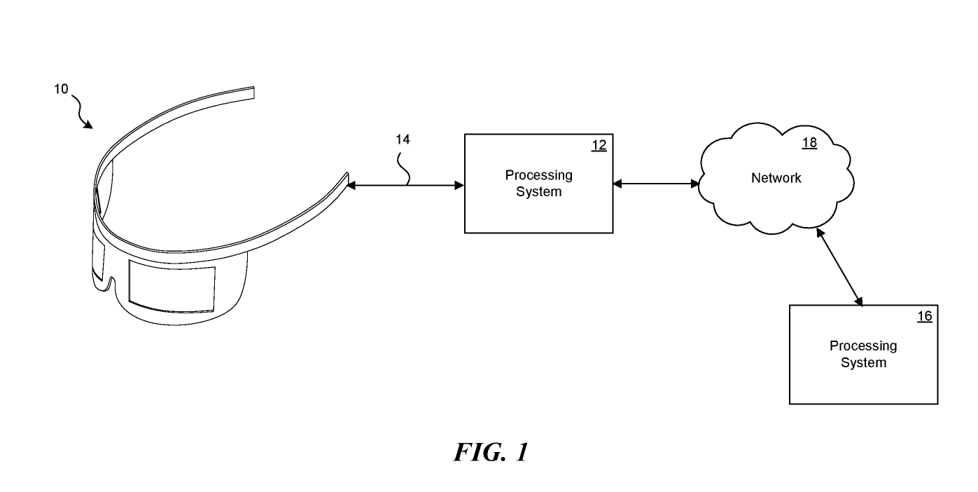

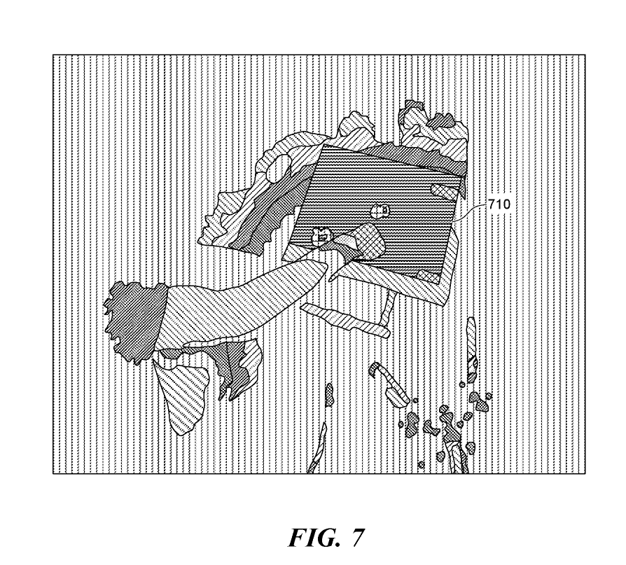

FIGS. 1 through 9 and related text describe certain embodiments of a technology for detecting a user interaction with a virtual object in the context of near-to-eye display systems or HMD devices. However, the disclosed embodiments are not limited to NED systems or (more specifically) HMD devices and have a variety of possible applications, such as in light projection systems, head-up display (HUD) systems or other types of AR systems.

FIG. 1 schematically shows an example of an environment in which an HMD device can be used. In the illustrated example, the HMD device 10 is configured to communicate data to and from an external processing system 12 through a connection 14, which can be a wired connection, a wireless connection, or a combination thereof. In other use cases, however, the HMD device 10 may operate as a standalone device. The connection 14 can be configured to carry any kind of data, such as image data (e.g., still images and/or full-motion video, including 2D and 3D images), audio, multimedia, voice, and/or any other type(s) of data. The processing system 12 may be, for example, a game console, personal computer, tablet computer, smartphone, or other type of processing device. The connection 14 can be, for example, a universal serial bus (USB) connection, Wi-Fi connection, Bluetooth or Bluetooth Low Energy (BLE) connection, Ethernet connection, cable connection, digital subscriber line (DSL) connection, cellular connection (e.g., 3G, LTE/4G or 5G), or the like, or a combination thereof. Additionally, the processing system 12 may communicate with one or more other processing systems 16 via a network 18, which may be or include, for example, a local area network (LAN), a wide area network (WAN), an intranet, a metropolitan area network (MAN), the global Internet, or combinations thereof.

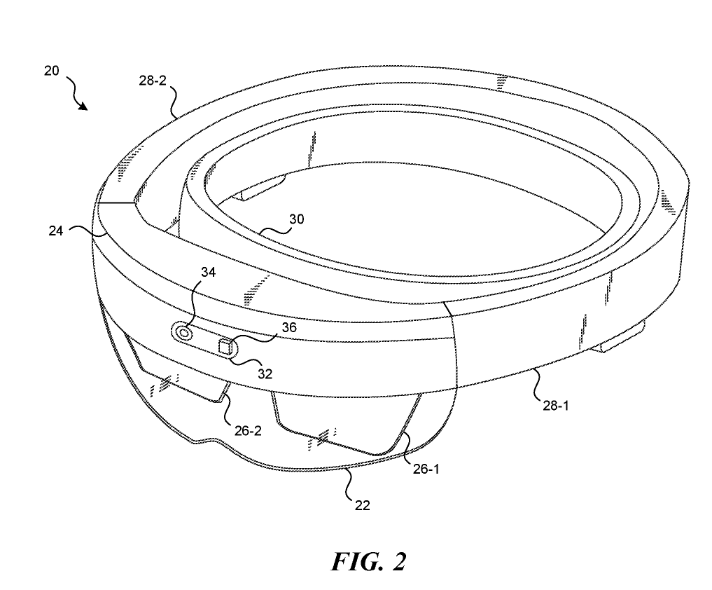

FIG. 2 shows a perspective view of an HMD device 20 that can incorporate the features being introduced here, according to certain embodiments. The HMD device 20 can be an embodiment of the HMD device 10 of FIG. 1. The HMD device 20 has a protective sealed visor assembly 22 (hereafter the “visor assembly 22”) that includes a chassis 24. The chassis 24 is the structural component by which display elements, optics, sensors and electronics are coupled to the rest of the HMD device 20. The chassis 24 can be formed of molded plastic, lightweight metal alloy, or polymer, for example.

The visor assembly 22 includes left and right AR displays 26-1 and 26-2, respectively. The AR displays 26-1 and 26-2 are configured to display images overlaid on the user's view of the real-world environment, for example, by projecting light into the user's eyes. Left and right side arms 28-1 and 28-2, respectively, are structures that attach to the chassis 24 at the left and right open ends of the chassis 24, respectively, via flexible or rigid fastening mechanisms (including one or more clamps, hinges, etc.). The HMD device 20 includes an adjustable headband (or other type of head fitting) 30, attached to the side arms 28-1 and 28-2, by which the HMD device 20 can be worn on the user's head.

The chassis 24 may include various fixtures (e.g., screw holes, raised flat surfaces, etc.) to which a sensor assembly 32 and other components can be attached. In some embodiments the sensor assembly 32 is contained within the visor assembly 22 and mounted to an interior surface of the chassis 24 via a lightweight metal frame (not shown). A circuit board (not shown in FIG. 2) bearing electronics components of the HMD 20 (e.g., microprocessor, memory) can also be mounted to the chassis 24 within the visor assembly 22.

The sensor assembly 32 includes a depth camera 34 and an illumination module 36 of a depth imaging system. The illumination module 36 emits light to illuminate a scene. Some of the light reflects off surfaces of objects in the scene, and returns back to the imaging camera 34. In some embodiments such as an active stereo system, the assembly can include two or more cameras. The depth camera 34 captures the reflected light that includes at least a portion of the light from the illumination module 36.

The “light” emitted from the illumination module 36 is electromagnetic radiation suitable for depth sensing and should not directly interfere with the user's view of the real world. As such, the light emitted from the illumination module 36 is typically not part of the human-visible spectrum. Examples of the emitted light include infrared (IR) light to make the illumination unobtrusive. Sources of the light emitted by the illumination module 36 may include LEDs such as super-luminescent LEDs, laser diodes, or any other semiconductor-based light source with sufficient power output.

The depth camera 34 may be or include any image sensor configured to capture light emitted by an illumination module 36. The depth camera 34 may include a lens that gathers reflected light and images the environment onto the image sensor. An optical bandpass filter may be used to pass only the light with the same wavelength as the light emitted by the illumination module 36. For example, in a structured light depth imaging system, each pixel of the depth camera 34 may use triangulation to determine the distance to objects in the scene. Any of various approaches known to persons skilled in the art can be used for determining the corresponding depth calculations.

The HMD device 20 includes electronics circuitry (not shown in FIG. 2) to control the operations of the depth camera 34 and the illumination module 36, and to perform associated data processing functions. The circuitry may include, for example, one or more processors and one or more memories. As a result, the HMD device 20 can provide surface reconstruction to model the user's environment, or be used as a sensor to receive human interaction information. With such a configuration, images generated by the HMD device 20 can be properly overlaid on the user's 3D view of the real world to provide a so-called augmented reality. Note that in other embodiments the aforementioned components may be located in different locations on the HMD device 20. Additionally, some embodiments may omit some of the aforementioned components and/or may include additional components not discussed above nor shown in FIG. 2. In some alternative embodiments, the aforementioned depth imaging system can be included in devices that are not HMD devices. For example, depth imaging systems can be used in motion sensing input devices for computers or game consoles, automotive sensing devices, earth topography detectors, robots, etc.

An AR enabled HMD device (or other NED display systems) enables a user to see AR content generated by the HMD device overlaid on a three-dimensional view of the real world around the user. Since the depth sensing device of the HMD device can resolve distances between the HMD device and physical surfaces of objects in the real-world environment, the HMD can generate AR content such as a virtual object that has a determined location (and orientation) relative to the real-world environment. Furthermore, the HMD device can determine a location of a body part (or a device) of the user using the depth sensing device. Based on the locations of the body part (e.g., hand) and the virtual object, the HMD device can identify an interaction between the virtual object and the user in an AR space.

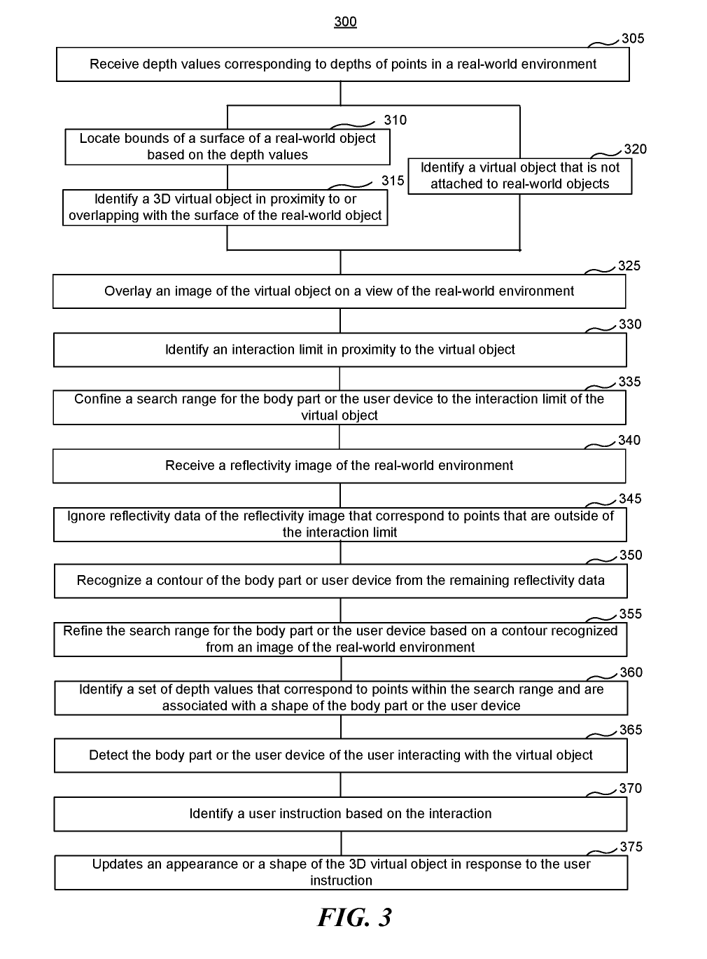

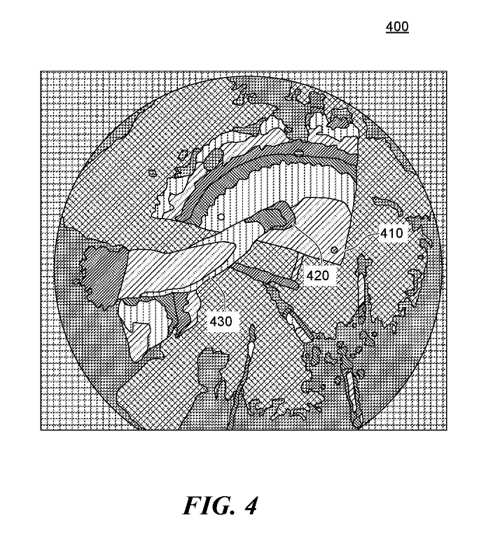

FIG. 3 illustrates an example of a process of detecting a user interaction with a virtual object in the AR space. The virtual object can be or include a virtual surface in proximity to or overlapping with a surface of a real-world object in the real-world environment. Alternatively, the virtual object can be a standalone virtual object that is not attached to a real-world object. At step 305 of the process 300, the HMD device receives from a depth sensing device (e.g., a ToF camera) a plurality of depth values corresponding to depths of points in a real-world environment relative to the HMD device. The depth values are collectively called depth map or depth image. The depth values are used to determine the locations of the real-world objects and the user's body part or user device. FIG. 4 illustrates an example of a depth map of a real-world environment. As shown in FIG. 4, the depth map 400 includes regions representing a table surface 410, a hand 420 and an arm 430.

At step 310, the HMD device locates the bounds of a surface of a real-world object near the user of the HMD device based on the depth values. The information of the bounds of the surface can include, e.g., position, width, height, and orientation of the surface. The surface can be, e.g., a surface of a wall, a surface of a table, etc.

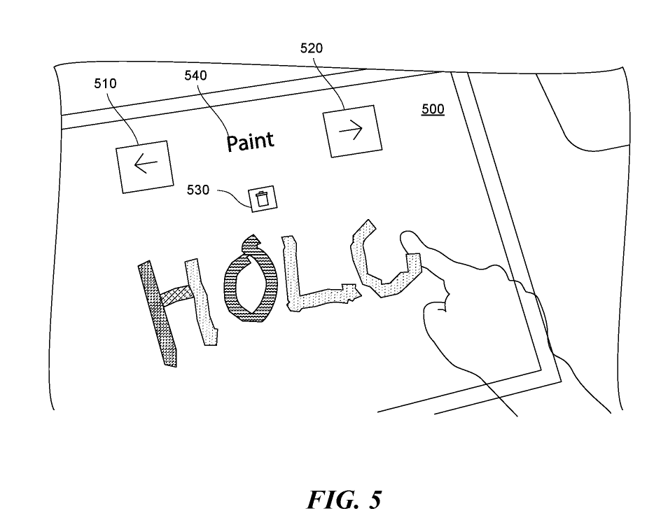

At step 315, the HMD device identifies a 3D virtual object in proximity to or overlapping with the surface of the real-world object and determines the location and orientation of the virtual object. For example, the virtual object can be a virtual surface overlapping a table surface as illustrated in FIG. 5. In other words, the virtual surface is coplanar with the physical surface of the table. As shown in FIG. 5, the virtual surface 500 can include graphic user interface (GUI) elements such as buttons 510, 520, 530 and caption 540. The user can interact with the virtual surface 500 using a body part (e.g., a finger or a hand), or a user device such as stylus. The interaction can be, e.g., drawing on the virtual surface or pressing a button on the virtual surface. The virtual surface can be planar or non-planar. For example, the virtual surface can be flat, spherical or cylindrical.

Alternatively, at step 320, the HMD device identifies a virtual object that is not attached to any real-world object. For example, the virtual object can be virtual touch screen that appears to the user to be floating in the air. At step 325, the HMD device overlays an image of the virtual object on a view of the real-world environment. Because the HMD device knows the depth map of the real-world environment and the location and orientation of the virtual object, the HMD can accurately overlay the virtual object in the three-dimensional AR space. At step 330, the HMD device identifies an interaction limit in proximity to the virtual object. For example, the interaction limit of the 3D virtual object for interaction detection can include a space in front of the virtual surface.

At step 335, the HMD device confines a search range for the body part or the user device to the interaction limit of the virtual object. In other words, the HMD device can ignore the depth values that correspond to points that are outside of the interaction limit. For example, if the virtual object is a virtual surface, the interaction limit can be a space in front of the virtual surface within a specified distance. Thus, the HMD device can ignore the depth values corresponding to points that are behind the virtual surface (which can include points on the surface of the real-world object). In other words, the points of the ignored depth values and the HMD device are at two opposite sides of the virtual surface. Furthermore, the HMD device can ignore depth values corresponding to points that are outside of the bounds of the virtual surface. Those depth values that correspond to points that are behind the virtual surface and outside of the bounds of the virtual surface are collectively called background noise, as those depth values interfere with identification of the body part or the user device interacting with the virtual surface. The HMD device discards depth values that are outside of region 710 because the points are outside of the bounds of the virtual surface. In some embodiments, the HMD device can remove the depth values corresponding to points that are outside of interaction limit from the depth map.

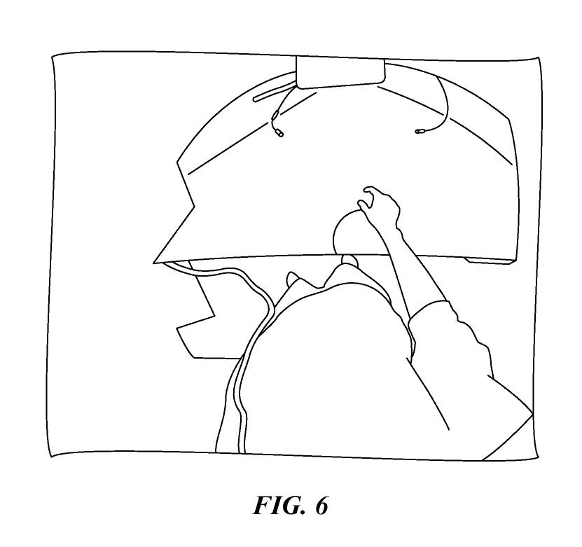

At step 340, the HMD device receives a reflectivity image of the real-world environment. The reflectivity image records light signals that are reflected from the real-world environment. For example, the reflectivity image can be an IR image of the real-world environment as shown in FIG. 6. Alternatively, the reflectivity image can be a photo that records light signals of a human-visible spectrum (e.g., a color photo, a color channel of a color photo, or a black and white photo of the real-world environment). In some embodiment, an image sensor of the depth sensing device (e.g., the image sensor of the depth camera 34) captures the reflectivity image as part of the process of generating the depth map. In some other embodiments, an image sensor separated from the depth sensing device captures the reflectivity image.

At step 345, the HMD device further ignores reflectivity data of the reflectivity image that correspond to points that are outside of the interaction limit (e.g., points that are outside of the bounds of the virtual surface) to improve the processing efficiency. At step 350, the HMD device recognizes a contour of the body part or user device from the remaining reflectivity data. In some embodiments, the HMD device recognizes the contour by identifying edges based on contrast of the reflectivity data and matches the identified edges with a known contour of the body part or user device.

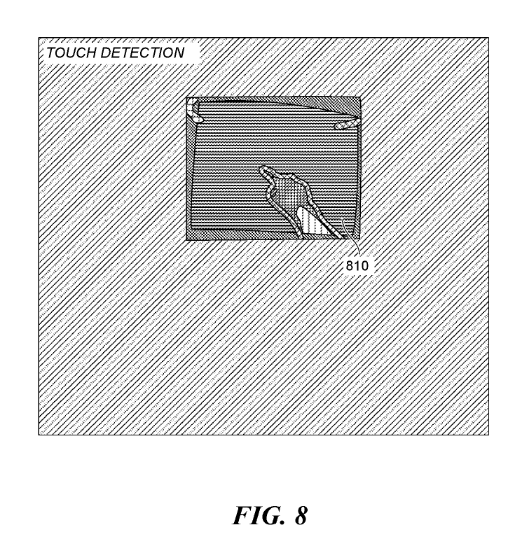

At step 355, the HMD device further refines the search range for the body part or the user device based on a contour recognized from an image of the real-world environment. FIG. 8 illustrates an example of a search range 810 that represents the shape of a user's hand. The contour that is recognized from the reflectivity data helps to further refine the search range.

In some alternative embodiments, the HMD device can perform the process 300 without refining the search range based on reflectivity data as shown in steps 345, 350 and 355. For example, the HMD device can identify the boundary of the search range just based on the depth values and not based on the reflectivity data.

At step 360, the HMD device identifies a set of depth values that correspond to points within the search range and are associated with a shape of the body part or the user device. The localized search can recognize the hand by searching a set of depth pixels near the virtual surface and within the search range. The HMD device can analyze one or more candidate sets of depth pixels to determine whether a candidate set is associated with a shape of a body part (e.g., a hand or a finger) or a user device (e.g., a stylus). In some embodiments, the HMD device can perform the analysis using a machine learning technique for matching a candidate set of depth pixels with a known pattern of the body part of the user device. For example, The HMD device can feed the candidate set of depth pixels into a trained neural network to decide whether the candidate set of depth pixels corresponds to a known pattern of the body part of the user device.

At step 365, based on locations of the body part or user device and the virtual object, the HMD device detects the body part or the user device of the user interacting with the virtual object. Based on the locations and orientations of the body part (or user device) and the virtual object, the HMD device can recognize various types of user interactions with the virtual object. For example, if a distance between a fingertip of a user and a virtual surface is within a threshold value, the HMD device can determine that the finger tip of the user is touching the virtual surface. As illustrated in FIG. 5, if a user's fingertip is in proximity to the button 510, 520 or 530, the HMD device determines that the user touches the button 510, 520 or 530 and responds to the user interaction (e.g., by changing the graphic user interface of the virtual surface 500). In some embodiments, the HMD device determines the user interaction with the virtual object based on the current frame of a data stream of depth maps. Each frame of the data stream includes a depth map recorded at a specific time point. In other words, the HMD device can detect the interaction in a real time based on frames of the data stream of depth maps. The HMD device (and the user's head) can move independently from the virtual object while the HMD device determines the user interaction with the virtual object in a real time.

At step 370, the HMD device identifies a user instruction based on the interaction. At step 375, the HMD device updates an appearance or a shape of the 3D virtual object in response to the user instruction. The HMD device can recognize various types of user interactions with virtual objects. For example, in some embodiments, the HMD device can recognize that a user moves one or more fingers on a surface of a virtual object (e.g., a virtual surface). The MD device can identify the interaction as an instruction to pan a user interface element (e.g., an image or a map) across the surface or to draw on the surface (as illustrated in FIG. 5). In some embodiments, the HMD device can also recognize that a user pinches two fingers on the surface of the virtual object. The HMD device can identify the interaction as an instruction to zoom in or zoom out an interface element (e.g., an image or a map) on the surface.

In some embodiments, the HMD device can recognize that a user slides one or more fingers up or down on the surface of the virtual object. The HMD device can identify the interaction as an instruction to scroll up or down an interface element (e.g., a document page or a web page) on the surface. In some embodiments, the HMD device can recognize that a user touches the surface of the virtual object and then slides one or more fingers on the surface. The HMD device can identify the interaction as an instruction to slide an interface element (e.g., a slider) on the surface.

In some embodiments, the HMD device can recognize that a user touches (or moves one or more fingers within a predetermined range of) the surface of the virtual object. The HMD device can identify the interaction as an instruction to click a user interface element (e.g., a button) on the surface. In some embodiments, the virtual object can include a virtual keyboard and the HMD device can identify the clicking interaction as an instruction to press a key of the virtual keyboard.

In some embodiments, the HMD device can recognize that a user pinches fingers around an element of the virtual object. The HMD device can identify the interaction as an instruction to grab (or drag) the element by the user's hand. The HMD device can further recognize that the user's hand (with pinching fingers) moves away from the virtual object. The HMD device can identify the interaction as an instruction to move the element away from the rest of the virtual object, or an instruction to extrude a 3D object (which includes the element) off from a surface of the virtual object.

The user interaction does not necessarily involve a user's body part (or a user device) touching any part of the virtual object. For example, in some embodiments, when a user's hand moves closer to and then farther away from a surface of the virtual object, the HMD device can identify the motion as an instruction to move an element up and down on the surface of the virtual object corresponding to the hand movement. In other words, a user's hand motion can remotely control movement of an element of the virtual object.

The HMD device can recognize user interactions involving more than one hand of the user. For example, in some embodiments, the HMD device can recognize that a user's two hands touch surfaces of a virtual object (e.g., a virtual object representing a ball). The HMD device can identify the interaction as an instruction to hold the virtual object (e.g., holding a virtual ball in the AR space) by the hands. When the user moves the two hands together, in response the HMD device can move the virtual object in the AR space based on the positions of the two hands.

Using the technology introduced herein, the HMD device can turn any surface (e.g., walls or tabletops) into an interactive surface (e.g., a virtual touch screen) in the AR space. The HMD device can even create an interactive surface that is not attached to any real-world object, such as a virtual touch screen floating in the air in the AR space.

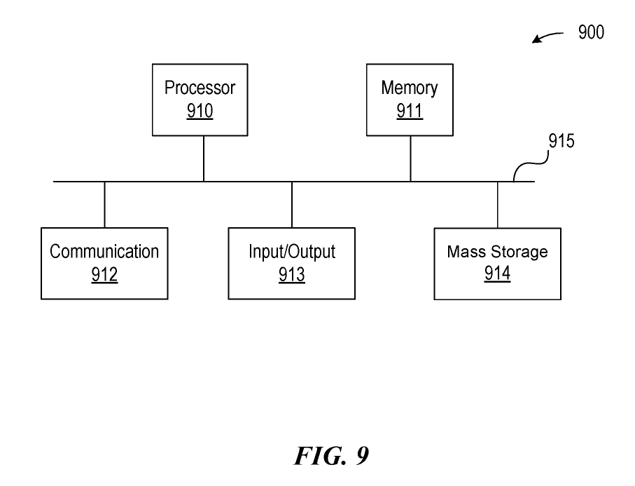

FIG. 9 shows a high-level example of a hardware architecture of a processing system that can be used to implement to perform the disclosed functions (e.g., steps of the process 600). The processing system illustrated in FIG. 9 can be part of an NED device or an AR device. One or multiple instances of an architecture such as shown in FIG. 9 (e.g., multiple computers) can be used to implement the techniques described herein, where multiple such instances can be coupled to each other via one or more networks.

The illustrated processing system 900 includes one or more processors 910, one or more memories 911, one or more communication device(s) 912, one or more input/output (I/O) devices 913, and one or more mass storage devices 914, all coupled to each other through an interconnect 915. The interconnect 915 may be or include one or more conductive traces, buses, point-to-point connections, controllers, adapters and/or other conventional connection devices. Each processor 910 controls, at least in part, the overall operation of the processing device 900 and can be or include, for example, one or more general-purpose programmable microprocessors, digital signal processors (DSPs), mobile application processors, microcontrollers, application specific integrated circuits (ASICs), programmable gate arrays (PGAs), or the like, or a combination of such devices.

Each memory 911 can be or include one or more physical storage devices, which may be in the form of random access memory (RAM), read-only memory (ROM) (which may be erasable and programmable), flash memory, miniature hard disk drive, or other suitable type of storage device, or a combination of such devices. Each mass storage device 914 can be or include one or more hard drives, digital versatile disks (DVDs), flash memories, or the like. Each memory 911 and/or mass storage 914 can store (individually or collectively) data and instructions that configure the processor(s) 910 to execute operations to implement the techniques described above. Each communication device 912 may be or include, for example, an Ethernet adapter, cable modem, Wi-Fi adapter, cellular transceiver, baseband processor, Bluetooth or Bluetooth Low Energy (BLE) transceiver, or the like, or a combination thereof. Depending on the specific nature and purpose of the processing system 900, each I/O device 913 can be or include a device such as a display (which may be a touch screen display), audio speaker, keyboard, mouse or other pointing device, microphone, camera, etc. Note, however, that such I/O devices may be unnecessary if the processing device 900 is embodied solely as a server computer.

In the case of a user device, a communication device 912 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, a communication device 912 can be or include, for example, any of the aforementioned types of communication devices, a wired Ethernet adapter, cable modem, DSL modem, or the like, or a combination of such devices.

The machine-implemented operations described above can be implemented at least partially by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software or firmware to implement the embodiments introduced here may be stored on a machine-readable storage medium and may be executed by one or more general-purpose or special-purpose programmable microprocessors. A “machine-readable medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

### Examples of Certain Embodiments

Certain embodiments of the technology introduced herein are summarized in the following numbered examples:

1. An apparatus of detecting a user interaction with a virtual object, the apparatus including: means for receiving from a depth sensing device a plurality of depth values corresponding to depths of points in a real-world environment relative to the depth sensing device; means for overlaying an image of a three-dimensional (3D) virtual object on a view of the real-world environment and identifying an interaction limit in proximity to the 3D virtual object; and means for detecting that a body part or a user device of a user is interacting with the 3D virtual object based on depth values of points that are within the interaction limit.

2. The apparatus of example 1, further including: means for confining a search range for the body part or the user device to the interaction limit of the 3D virtual object; and means for identifying a set of depth values that correspond to points within the search range and are associated with a shape of the body part or the user device.

3. The apparatus of example 2 or 3, further including: means for recognizing a contour from an image of the real-world environment; and means for refining a search range for the body part or the user device based on the contour recognized from the image of the real-world environment.

4. The apparatus of example 3, further including: means for capturing the image of the real-world environment by a camera component of the depth sensing device.

5. The apparatus of example 3 or 4, wherein the contour represents a form of the body part or the user device of the user.

6. The apparatus in any of the preceding examples 1 through 5, wherein the 3D virtual object includes a virtual surface in proximity to or overlapping with a surface of a real-world object in the real-world environment, and the interaction limit of the 3D virtual object includes a space in front of the virtual surface.

7. The apparatus of example 6, further including: means for excluding from the search range depth values that correspond to points on the surface of the real-world object.

8. The apparatus of example 6 or 7, further including: means for excluding from the search range depth values that correspond to points outside of bounds of the virtual surface.

9. The apparatus in any of the preceding examples 6 through 8, wherein the depth sensing device is a stereo vision camera, a time-of-flight camera, or structured light depth camera.

10. The apparatus in any of the preceding examples 6 through 9, further including: means for identifying a user instruction based on locations of the body part or the user device and the 3D virtual object.

11. The apparatus of example 10, further including: means for updating the image of the 3D virtual object overlaid on the view of the real-world environment, in response to the user instruction.

12. The apparatus of example 10 or 11, further including: means for updating a 3D shape of the 3D virtual object overlaid on the view of the real-world environment, in response to the user instruction.

13. The apparatus in any of the preceding examples 1 through 12, further including: means for identifying a user instruction to interact with a user interface element of the 3D virtual object based on locations of the body part or the user device and the user interface element of the 3D virtual object; and means for adjusting a status of the user interface element in response to the user instruction.

14. The apparatus in any of the preceding examples 1 through 13, further including: means for identifying a user instruction to interact with an element of the 3D virtual object based on locations of the body part or the user device and the element of the 3D virtual object; and means for adjusting a 3D shape of the element of the 3D virtual object in response to the user instruction.

15. The apparatus in any of the preceding examples 1 through 14, further including: means for identifying a user instruction to drag an element of the 3D virtual object based on locations of the body part or the user device and the element of the 3D virtual object; and means for extruding a 3D object including the element off from a surface of the 3D virtual object in response to the user instruction.

16. An augmented reality display device including: a depth sensing device recording a plurality of depth values corresponding to depths of points in a real-world environment relative to the depth sensing device; a display that, when in operation, overlays an image of a three-dimensional (3D) virtual object on a view of the real-world environment; and a processor that, when in operation, performs a process including: identifying an interaction limit in proximity to the 3D virtual object, and detecting a body part or a user device of a user interacting with the 3D virtual object based on depth values of points that are within the interaction limit.

17. The augmented reality display device of example 16, wherein the process includes: confining a search range for the body part or the user device to the interaction limit of the 3D virtual object; and identifying a set of depth values that correspond to points within the search range and are associated with a shape of the body part or the user device.

18. The augmented reality display device of example 17, wherein the process further includes: recognizing a contour from an image of the real-world environment; and further refining the search range for the body part or the user device based on the contour recognized from the image of the real-world environment.

19. The augmented reality display device in any of the preceding examples 16 through 18, wherein the 3D virtual object includes a virtual surface in proximity to or overlapping with a surface of a real-world object in the real-world environment, and the interaction limit of the 3D virtual object includes a space in front of the virtual surface.

20. A near-to-eye display device including: a depth sensing device recording a plurality of depth values corresponding to depths of points in a real-world environment relative to the depth sensing device; a display that, when in operation, overlays an image of a three-dimensional (3D) virtual object on a view of the real-world environment; and a processor that, when in operation, performs a process including: identifying an interaction limit in proximity to the 3D virtual object, recognizing a body part or a user device of a user based on depth values of points within the interaction limit, and updating an appearance or a shape of the 3d virtual object in response to the body part or the user device interacting with the 3D virtual object.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. A method of detecting a user interaction with a virtual object, the method comprising:
receiving from a depth sensing device a plurality of depth values corresponding to depths of points in a real-world environment relative to the depth sensing device;
overlaying an image of a three-dimensional (3D) virtual object on a view of the real-world environment such that the 3D object is displayed relative to and unattached to a real world physical objects;
identifying an interaction limit in proximity to the 3D virtual object; and
detecting that a body part is interacting with the 3D virtual object based on depth values of points that are within the interaction limit.

2. The method of claim 1, further comprising:
confining a search range for the body part or the user device to the interaction limit of the 3D virtual object; and
identifying a set of depth values that correspond to points within the search range and are associated with a shape of the body part.

3. The method of claim 2, further comprising:
recognizing a contour from an image of the real-world environment; and
further refining the search range for the body part based on the contour recognized from the image of the real-world environment.

4. The method of claim 3, further comprising:
capturing the image of the real-world environment by a camera component of the depth sensing device.

5. The method of claim 3, wherein the contour represents a form of the body part.

6. The method of claim 1, wherein the 3D virtual object comprises a virtual surface in proximity to or overlapping with a surface of a real-world object in the real-world environment, and the interaction limit of the 3D virtual object comprises a space in front of the virtual surface.

7. The method of claim 6, further comprising:
excluding, from a search range, depth values that correspond to points on the surface of the real-world object.

8. The method of claim 6, further comprising:
excluding, from a search range, depth values that correspond to points outside of bounds of the virtual surface.

9. The method of claim 6, wherein the depth sensing device is a stereo vision camera, a time-of-flight camera, or structured light depth camera.

10. The method of claim 1, further comprising:
identifying a user instruction based on locations of the body part and the 3D virtual object.

11. The method of claim 10, further comprising:
updating the image of the 3D virtual object overlaid on the view of the real-world environment, in response to the user instruction.

12. The method of claim 10, further comprising:
updating a 3D shape of the 3D virtual object overlaid on the view of the real-world environment, in response to the user instruction.

13. The method of claim 1, further comprising:
identifying a user instruction to interact with a user interface element of the 3D virtual object based on locations of the body part and the user interface element of the 3D virtual object; and
adjusting a status of the user interface element in response to the user instruction.

14. The method of claim 1, further comprising:
identifying a user instruction to interact with an element of the 3D virtual object based on locations of the body part and the element of the 3D virtual object; and
adjusting a 3D shape of the element of the 3D virtual object in response to the user instruction.

15. The method of claim 1, further comprising:
identifying a user instruction to drag an element of the 3D virtual object based on locations of the body part and the element of the 3D virtual object; and
extruding a 3D object including the element off from a surface of the 3D virtual object in response to the user instruction.

16. An augmented reality display device comprising:
a depth sensing device recording a plurality of depth values corresponding to depths of points in a real-world environment relative to the depth sensing device;
a display that, when in operation, overlays an image of a three-dimensional (3D) virtual object on a view of the real-world environment such that the 3D object is displayed relative to and unattached to a real world physical objects; and
a processor that, when in operation, performs a process including:
identifying an interaction limit in proximity to the 3D virtual object; and
detecting a body part interacting with the 3D virtual object based on depth values of points that are within the interaction limit.

17. The augmented reality display device of claim 16, wherein the process includes:
confining a search range for the body part to the interaction limit of the 3D virtual object; and
identifying a set of depth values that correspond to points within the search range and are associated with a shape of the body part or the user device.

18. The augmented reality display device of claim 17, wherein the process further includes:
recognizing a contour from an image of the real-world environment; and
further refining the search range for the body part based on the contour recognized from the image of the real-world environment.

19. The augmented reality display device of claim 16, wherein the 3D virtual object comprises a virtual surface in proximity to or overlapping with a surface of a real-world object in the real-world environment, and the interaction limit of the 3D virtual object comprises a space in front of the virtual surface.

20. A near-to-eye display device comprising:
a depth sensing device recording a plurality of depth values corresponding to depths of points in a real-world environment relative to the depth sensing device;
a display that, when in operation, overlays an image of a three-dimensional (3D) virtual object on a view of the real-world environment such that the 3D object is displayed relative to and unattached to a real world physical objects; and
a processor that, when in operation, performs a process including:
identifying an interaction limit in proximity to the 3D virtual object;
recognizing a body part based on depth values of points within the interaction limit, and
updating an appearance or a shape of the 3d virtual object in response to the body part or the user device interacting with the 3D virtual object.
